(19) United States
(12) Patent Application Publication
(10) Pub. No.: US 2025/0243048 A1
(43) Pub. Date: Jul. 31, 2025

(54) PRESENCE-RESPONSIVE REFRIGERATOR APPLIANCE AND FLUID DISPENSER

(71) Applicant: Haier US Appliance Solutions, Inc., Wilmington, DE (US)

(72) Inventors: Leonardo Falcon Izzi, Louisville, KY (US); Joseph Thomas Waugh, Louisville, KY (US)

(21) Appl. No.: 18/427,233

(22) Filed: Jan. 30, 2024

(51) Int. Cl. B67D 1/12; B67D 1/00; B67D 1/08; F25D 23/12

(52) U.S. Cl. CPC B67D 1/1238; B67D 1/0014; B67D 1/0888; F25D 23/126; F25D 2400/361; F25D 2700/04

(57) ABSTRACT

A refrigerator or dispenser appliance may include a cabinet, a door, a dispenser assembly, a user-detection assembly, and a controller. The dispenser assembly may be attached to the cabinet at a dispenser recess. The dispenser assembly may include a dispenser conduit disposed within the dispenser recess, and a liquid level sensor mounted at the dispenser recess to detect a volume below the dispenser conduit. The user-detection assembly may be mounted to the cabinet to detect a user presence. The controller may be operably coupled to the dispenser assembly and the user-detection assembly. The controller may be configured to initiate an operation routine. The operation routine may include receiving an autofill signal for the dispenser assembly, evaluating user presence using the user-detection assembly, and directing, subsequent to receiving the autofill signal, the dispenser assembly based on the evaluated user presence.

### FIELD OF THE DISCLOSURE

The present subject matter relates generally to refrigerator appliances, and more particularly to fluid dispensing assemblies for the same.

### BACKGROUND OF THE DISCLOSURE

Appliances, such as refrigerator appliances, generally include one or more cabinets defining chambers for the receipt of food items for storage. Appliances may also include features for dispensing fluids, such as ice or liquid water. In certain of such appliances, both hot and cold water may be provided. Moreover, in some appliances, coffee or other beverages may be dispensed as well. Often, these dispensers include some sort of recess or compartment into which a container or vessel, such as a cup, is placed to receive the dispensed substance. During use, a user may position a container proximate the dispenser, and fluid is deposited into the container depending upon the user's selection. A paddle or other type switch may be provided whereby the user may make a selection. Typically, the liquid water is chilled by routing the liquid water through one of the refrigerated chambers.

In some cases, it may be useful to provide one or more features for precisely dispensing or filling a container with a specific volume of liquid (e.g., beverage), such as a predetermined or user-specified volume of liquid. Some such systems have been referred to as “auto-fill” dispensers or dispensing assemblies and may rely on, for example one or more ultrasonic sensors. In spite of the advantages of these systems, certain disadvantages exist. For instance, it can be difficult for some systems to consistently obtain accurate information regarding a container to be filled (e.g., beneath an outlet of the dispenser). Under certain conditions it may be possible for the dispensing to be initiated or continue even though a user or container is not near the system, leading to the potential for the dispenser to direct significant volumes of liquid to the surrounding area.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a refrigerator appliance is provided. The refrigerator appliance may include a cabinet, a door, a dispenser assembly, a user-detection assembly, and a controller. The cabinet may define a storage compartment. The door may be attached to the cabinet to selectively restrict access to the storage compartment. The dispenser assembly may be attached to the cabinet at a dispenser recess. The dispenser assembly may include a dispenser conduit disposed within the dispenser recess, and a liquid level sensor mounted at the dispenser recess to detect a volume below the dispenser conduit. The user-detection assembly may be mounted to the cabinet to detect a user presence. The controller may be operably coupled to the dispenser assembly and the user-detection assembly. The controller may be configured to initiate an operation routine. The operation routine may include receiving an autofill signal for the dispenser assembly, evaluating user presence using the user-detection assembly, and directing, subsequent to receiving the autofill signal, the dispenser assembly based on the evaluated user presence.

In another exemplary aspect of the present disclosure, a dispenser assembly is provided. The dispenser assembly may include a cabinet, a dispenser assembly, a user-detection assembly, and a controller. The dispenser assembly may be attached to the cabinet. The dispenser assembly may include a dispenser conduit, and a liquid level sensor to detect a volume below the dispenser conduit. The user-detection assembly may be mounted to the cabinet to detect a user presence. The controller may be operably coupled to the dispenser assembly and the user-detection assembly. The controller may be configured to initiate an operation routine. The operation routine may include receiving an autofill signal for the dispenser assembly, evaluating user presence using the user-detection assembly, and directing, subsequent to receiving the autofill signal, the dispenser assembly based on the evaluated user presence.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of an appliance in accordance with aspects of the present disclosure.

FIG. 2 provides a front, elevation view of an embodiment of a dispenser assembly of the exemplary appliance of FIG. 1.

FIG. 3 provides another front, elevation view of an embodiment of a dispenser assembly of the exemplary appliance of FIG. 1.

FIG. 4 provides a flow chart illustrating a method of operating an appliance according to exemplary embodiments of the present disclosure.

FIG. 5 provides a flow chart illustrating a method of operating an appliance according to exemplary embodiments of the present disclosure.

FIG. 6 provides a flow chart illustrating a method of operating an appliance according to exemplary embodiments of the present disclosure.

FIG. 7 provides a flow chart illustrating a method of operating an appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The terms “coupled,” “fixed,” “attached to,” and the like refer to both direct coupling, fixing, or attaching, as well as indirect coupling, fixing, or attaching through one or more intermediate components or features, unless otherwise specified herein.

The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Terms such as “inner” and “outer” refer to relative directions with respect to the interior and exterior of the refrigerator appliance, and in particular the food storage chamber(s) defined therein. For example, “inner” or “inward” refers to the direction towards the interior of the refrigerator appliance. Terms such as “left,” “right,” “front,” “back,” “top,” or “bottom” are used with reference to the perspective of a user accessing the refrigerator appliance. For example, a user stands in front of the refrigerator to open the doors and reaches into the food storage chamber(s) to access items therein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Aspects of the present disclosure may advantageously provide an appliance or methods of operating the same in which an autofill sequence or operation may be executed at a dispenser assembly while preventing a spill. Notably, the appliance or methods may determine a user's presence (e.g., present or absent) relative to the appliance and adjust or prevent the autofill sequence based on the determination.

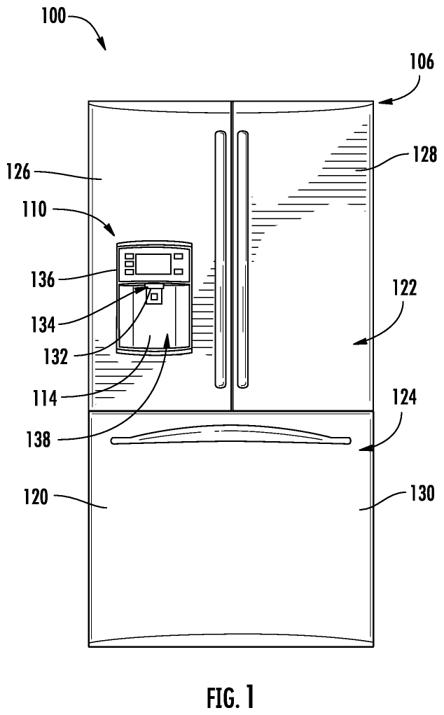

Referring now to the figures, FIG. 1 depicts a front view of an example embodiment of an appliance 100. The appliance 100 may particularly form a refrigerator appliance. The appliance 100 may include a cabinet or housing 120 defining an upper fresh food chamber 122 and a lower freezer chamber 124 arranged below the fresh food chamber 122. As such, appliance 100 may generally be referred to as a bottom-mount refrigerator appliance. In the exemplary embodiment, housing 120 also defines a mechanical compartment (not shown) for receipt of a sealed cooling system. Using the teachings disclosed herein, one of skill in the art will understand that the present disclosure may be used with other types of refrigerator appliances (e.g., side-by-sides or top-mounts), freezer appliances, fluid dispensers generally, or other appropriate appliances. Consequently, the description set forth herein is for illustrative purposes only and is not intended to limit the invention to any particular style or arrangement of appliance.

Refrigerator doors 126, 128 are rotatably hinged to an edge of housing 120 for accessing fresh food compartment 122. A freezer door 130 is arranged below refrigerator doors 126, 128 for accessing freezer chamber 124. In the exemplary embodiment, freezer door 130 is coupled to a freezer drawer (not shown) slidably mounted within freezer chamber 124.

Appliance 100 includes a dispenser assembly 110 for dispensing liquid water and ice. Dispenser assembly 110 includes a dispenser 114 positioned on an exterior portion of appliance 100. Dispenser 114 includes a discharging outlet 134 for accessing ice and liquid water. Dispenser assembly 110 further includes a LLS 112 positioned on discharging outlet 134. As will be described in more detail below, LLS 112 may be configured to detect a presence of a container positioned within dispenser assembly 110, and to detect the top lip of the container. A user interface panel 136 is provided for controlling the mode of operation. For example, user interface panel 136 includes a water dispensing button (not labeled) and an ice-dispensing button (not labeled) for selecting a desired mode of operation such as crushed, non-crushed ice, or liquid water, etc.

Discharging outlet 134 is an external part of dispenser 114, and is mounted in a dispensing recess or recessed portion 138 defined in an outside surface of refrigerator door 126. Recessed portion 138 is positioned at a predetermined elevation convenient for a user to access ice or liquid water and enabling the user to access ice or liquid water without the need to bend-over and without the need to access freezer chamber 124. In the exemplary embodiment, recessed portion 138 is positioned at a level that approximates the chest level of a user.

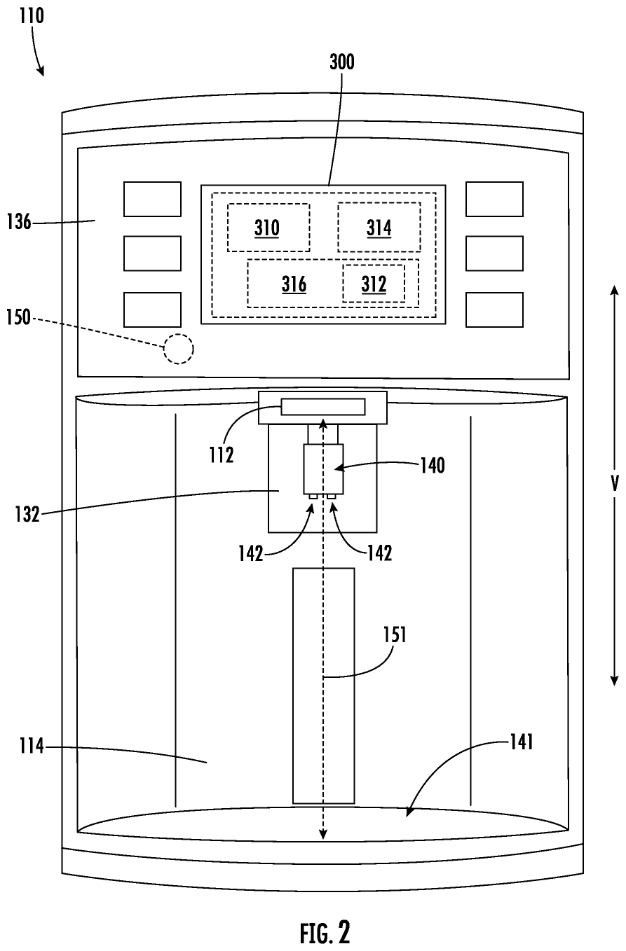

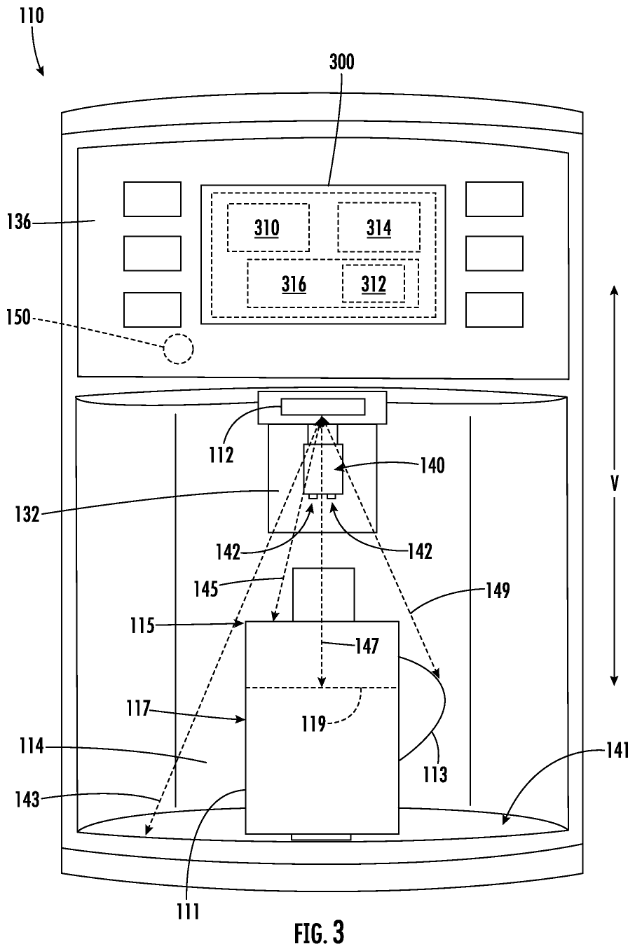

FIGS. 2 and 3 provide a close-up front view of embodiments of the dispenser 114 of dispenser assembly 110. Operation of the appliance 100 is regulated by a control device or controller 300 that is operatively coupled to user interface panel 136 or LLS 112. The controller 300 may include one or more processors 314 and one or more memory devices 316. The one or more memory devices 316 may be configured to store instructions that, when executed by the one or more processors 314, causes the appliance 100 to perform operations such as provided below. The memory device(s) 316 may be configured to data corresponding to one or more signals, functions, charts, tables, schedules, or determined values such as provided herein.

Panel 136 provides selections for user manipulation of the operation of appliance 100 such as e.g., selections between whole or crushed ice, chilled liquid water, or other options. In response to user manipulation of the user interface panel 136, the controller 300 operates various components of the appliance 100. The controller 300 may be positioned in a variety of locations throughout appliance 100. In the illustrated embodiment shown in FIG. 1, the controller 300 is located within or beneath the user interface panel 136 on door 126. In such an embodiment, input/output (“I/O”) signals may be routed between controller 300 and various operational components of appliance 100. In one exemplary embodiment, the user interface panel 136 may represent a general purpose I/O (“GPIO”) device or functional block. In another exemplary embodiment, the user interface 136 may include input components, such as one or more of a variety of electrical, mechanical or electro-mechanical input devices including rotary dials, push buttons, and touch pads. The user interface 136 may be in communication with the controller 300 via one or more signal lines or shared communication busses.

In some embodiments, an exemplary nozzle 140 is positioned adjacent to an activation member 132. Nozzle 140 includes one or more fluid outlets 142 through which liquid water may flow into a container placed into the recess 138 of dispenser assembly 110 by a user of appliance 100. Dispenser assembly 110 may further include a liquid level sensor (LLS), such as LLS 112. LLS 112 may be positioned above nozzle 140 within dispenser 114. In particular, LLS 112 may be positioned within an upper portion of dispenser 114. In certain operating modes, such as further described herein, one or more signals generated by LLS 112 are transmitted parallel to the liquid water stream. In this manner, LLS 112 may be positioned vertically above a container placed in dispenser 114.

In example embodiments, LLS 112 includes or is provided as an ultrasonic transducer configured to periodically transmit and receive high frequency sound waves, and to convert the received sound waves into electrical data. In particular, LLS 112 may be configured to generate and transmit a sound wave, and to receive one or more echoed sound waves. LLS 112 may further be configured to determine a time interval between transmitting the sound wave and receiving the one or more echoes. It will be appreciated that various other sensors or sensor configurations may be used, such as for instance, a sensor configuration including a separate and distinct transmitter and receiver.

In another embodiment, LLS 112 includes or is provided as a light transducer, such as, but not limited to, an infrared light sensor, a visible light sensor, or a camera. The LLS 112 configured as a light transducer may be configured to periodically transmit and receive light and to convert the received light into electrical data. In particular, LLS 112 may be configured to generate and transmit light and to receive reflected light. LLS 112 may further be configured to determine a time interval between transmitting the light and receiving the reflected light. It will be appreciated that various other sensors or sensor configurations may be used, such as for instance, a sensor configuration including a separate and distinct transmitter and receiver.

Separate from or in addition to LLS 112, dispenser assembly 110 (or appliance 100 in general) may include a user-detection assembly to detect a user presence. In particular, user-detection assembly may be mounted to cabinet 120 (e.g., directly or, alternatively, indirectly-such as via door 126). In the illustrated embodiments, user-detection assembly 150 is disposed on or rearward from panel 136. Nonetheless, any other suitable location may be provided. Generally, user-detection assembly 150 includes one or more sensors configured to detect the presence of a user (e.g., independently or apart from rotation of any door 126 or 128). As an example, user-detection assembly 150 may include a wireless module configured to wirelessly connect with a user device and receive a wireless connection signal (e.g., Wi-Fi, Bluetooth, or other appropriate communications medium) from a remote user device (e.g., smartphone, tablet, or wearable device, such as a smartwatch or mobile headset) in close proximity to the appliance 100, as would be understood.

As another example, user-detection assembly 150 may include a body sensor module, which is configured to detect the physical body (or direct characteristics thereof) of a user. Such a body sensor module may include a light transducer, such as, but not limited to, an infrared light sensor, a visible light sensor, or a camera, which is configured to receive a light emission detected or reflected from a user's body, as would be understood. Additionally or alternatively, the body sensor module may include an ultrasonic transducer configured to transmit one or more high frequency sound waves, and to receive one or more reflected high frequency sound waves. The sound waves received by the sensor may have associated time intervals corresponding to an amount of time between the transmission of the sound wave and reception of the corresponding reflected sound wave. The presence of a user may be detected at least in part on a comparison between the time interval of a received sound wave and a baseline time interval associated with a baseline signal. Further additionally or alternatively, the body sensor module may include a touch sensor, such as an imaging sensor, capacitive sensor, or resistive sensor (e.g., mounted on door 126), which is configured to emit one or more corresponding signals in response to touch or contact of a user on a predefined touch zone of the touch sensor, as would be understood.

Optionally, user-detection assembly 150 is configured to detect a biometric or personalized marker corresponding to a specific individual user and, thus, may not only detect the presence of a user, but also identify a specific user (e.g., from a collection of multiple discrete user's). As an example, user-detection assembly 150 may include a forward-facing camera configured to recognize or identify a user's face based on a captured two-dimensional image. As another example, user-detection assembly 150 may include a fingerprint imaging sensor configured to visually detect a user's fingerprint. As yet another example, user-detection assembly 150 may include a wireless module configured to detect a device address (e.g., of a user device) over a wireless communications band (e.g., a BLE band using short-wavelength UHF radio waves in the ISM band from 2.4 to 2.485 GHZ). The device address may be a programmed Bluetooth address of, for instance, a remote user device. The user-detection assembly 150 may thus determine if and when a remote user device is within close proximity to refrigerator appliance 100.

In certain embodiments, a secondary camera assembly is included as part of user-detection assembly 150. As an example, a secondary camera assembly (e.g., mounted to a door 126) user-detection assembly 150 may be directed outward (e.g., away from the cabinet 120 or chilled chamber 122) and may be configured to recognize or identify a user from a two-dimensional image captured at the secondary camera assembly. In some such embodiments, controller 300 is further configured to recognize one or more defining features, such as a user's face, skin tone, arm/hand size, jewelry, typical clothing, etc. As is understood, recognizing such defining features may be performed by edge matching, divide-and-conquer search, greyscale matching, histograms of receptive field responses, or another suitable routine (e.g., executed at the controller 300 based on one or more captured images from the secondary camera assembly).

In certain embodiments, the controller 300 is in operative communication with one or more of the panel 136, the dispenser 114, the LLS 112, and the user-detection assembly 150.

Optionally, the controller 300 may be configured to emit from the LLS 112 a first plurality of signals 151 defining a first operating mode. The first operating mode corresponds to a user presence detection mode (e.g., separate from or in addition to the user-detection assembly 150) during which a scan range of the LLS 112 is configured to emit and receive signals beyond the dispenser 114. The first operating mode includes one or more of a first field of view or first scan range, a first sampling rate or first scan rate, a first sampling interval or first scan interval, or combinations thereof. In some embodiments, the first scan range is a function of one or more of the first scan rate or the first scan interval. When in the first operating mode, the appliance 100 may optionally emit and receive signals from beyond the dispenser 114 and perform one or more operations based on the detection of a user. Example embodiments of such operations may include, but are not limited to, activating lights, displays, or providing information at the panel 136 when the user is detected (e.g., when signals corresponding to beyond the dispenser 114 are received by the LLS 112 or user-detection assembly 150 detects a user proximal to the appliance 100 as described above).

Additionally or alternatively, the controller 300 may be configured to detect a container (e.g., the presence thereof) within the dispensing recess 138 based at least in part on the one or more signals from the LLS 112. In certain embodiments, the controller 300 is configured to detect the container within the dispensing recess 138 based at least in part on receiving the first plurality of signals 151 and the second plurality of signals 152. The controller 300 may be configured to determine a proximity of the received signals. When the LLS 112 detects that the distance of the received signal is within a threshold range, the received signal corresponds the proximity of the received signals to detection of the presence of the container at the dispensing recess 138. When the presence of the container is detected, the controller 300 may be configured to emit from the LLS 112 a second plurality of signals 152 defining a second operating mode. The second operating mode corresponds to a container presence detection mode, during which the appliance 100 may dispense a fluid (e.g., liquid water or ice), detect a level or height of contents in the container, or perform another function based on the presence of the container at the dispensing recess 138. The second operating mode includes one or more of a second field of view or second scan range, a second sampling rate or second scan rate, a second sampling interval or second scan interval, or combinations thereof different from the first operating mode. For instance, the second sampling rate may be less than the first sampling rate. Additionally or alternatively, the second scan interval may be less than the first scan interval. Thus, the second operating mode may provide for skipping or delaying capture of a baseline signal in comparison to the first operating mode. In some embodiments, the second scan range is a function of one or more of the second scan rate or the second scan interval.

In various embodiments (e.g., including both the first operating mode and the second operating mode), the threshold between the second scan range and the first scan range corresponds approximately to a height or depth of the dispensing recess 138. In certain embodiments, the height of the dispensing recess 138 is approximately a distance from the LLS 112 to a drip tray 141 located distal to the LLS 112 along a vertical direction. The distance from the LLS 112 to the drip tray 141 may correspond to the threshold between the second scan range and the first scan range. The second scan range is greater than zero inches and less than the threshold, and the first scan range is greater than the threshold. Accordingly, the second scan range corresponding to detection of the container at the dispensing recess 138 is less than the first scan range corresponding to detection of the user around the appliance 100.

In optional embodiments, the change in operating modes at the LLS 112 includes the first scan interval that is greater (e.g., of at least approximately 2 times greater) than the second scan interval. In another embodiment, the change in operating modes at the LLS 112 includes the first scan interval of approximately 4 times greater than the second scan interval. The decrease in scan interval from the first operating mode to the second operating mode decreases the scan range and increases the resolution, such as may allow for sensing of fluid levels in the container, dispensing fluids based on the sensed fluid level, and terminating dispensation of fluids without spillage overflow, or excess. The increase in scan interval from the second operating mode to the first operating mode increases the scan range to allow for sensing when a user is in a room or area around the refrigeration device. While the resolution may decrease from the second operating mode to the first operating mode, the resolution is sufficient for detection of a user in the room or area around the appliance 100 in contrast to the resolution for detecting fluid levels at the container.

In an example embodiment, the threshold is greater than approximately 12 inches and less than approximately 14 inches. In a particular embodiment, the threshold is approximately 13.6 inches. As provided above, the controller 300 may be configured to determine a proximity of the received signals 151, 152. The controller 300 may further be configured to compare a rate of change of the proximity of the received signals 151, 152. In example embodiments, the controller 300 may be configured to anticipate a transition from the second operating mode to the first operating mode based on the rate of change of the proximity of the received signals 151, 152. As the distance of the received signal decreases toward the threshold, the controller 300 may anticipate the change from the second operating mode to the first operating mode, such as to decrease or eliminate a lag between changes in operating modes.

As noted above, LLS 112 may be configured to detect a presence of a container 111 positioned proximate or within dispenser 114. For instance, LLS 112 may transmit one or more signals (e.g., sound waves), and receive one or more signals (e.g., reflected sound waves) indicative of container 111. In particular, the presence of a container may be detected at least in part by a comparison of a received signal (e.g., second signal 152) with a baseline signal (e.g., first signal 151). The baseline signal may be a signal received by LLS 112 that is not reflected by a container. For instance, the baseline signal may be a signal transmitted by LLS 112 that is reflected, for instance, by a bottom surface of dispenser 114. Such signal may have an associated time interval corresponding to a particular known time interval (or range of time) for a signal transmitted by LLS 112 to return to LLS 112 in the absence of a container. When container 111 is positioned proximate dispenser 114, a different signal may be received corresponding at least in part to the signal reflected by container 111. Such signal may have a different corresponding time interval (or range of time), which may be indicative of the presence of container 111.

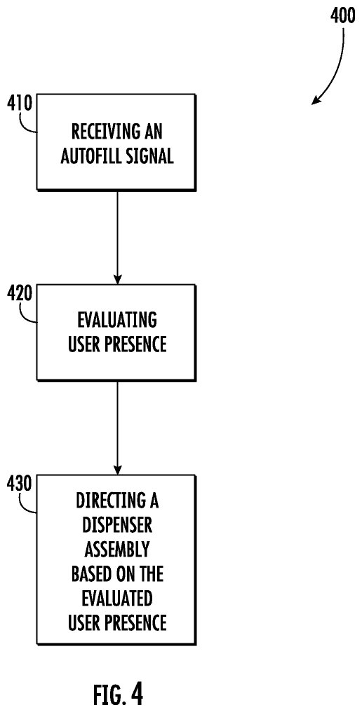

As will be described in greater detail below (e.g., with respect to FIGS. 4 through 7), dispenser 114 may be activated to initiate a flow of liquid water or ice into container 111. Such activation may be due, at least in part, in response to a user's presence or an input (e.g., autofill input) to user interface panel 136, e.g., indicative of a request to dispense liquid water or ice. Components of appliance 100 operable to dispense liquid water or ice are well known and not described in detail. As an example, the controller may open a water supply line valve to dispense liquid water. As another example, the controller open an ice chute door and activate an auger motor to dispense ice.

In optional embodiments, the controller 300 may operate dispenser 114 to initiate the flow of liquid water or ice into container 111 in response to an autofill input at user interface panel 136 based on detection of a user's presence. The controller 300 may be configured to direct the flow of fluid according to an autofill sequence. Generally, the autofill sequence may act to dispense fluid to a predetermined volume or level (e.g., programmed or selected by a user) in an automated fashion (e.g., without requiring continuous user input, as would be understood). For instance, LLS 112 may be configured to detect a level of liquid water or ice 119 in container 111 relative to a top lip 115 of container 111. For instance, when a container is positioned proximate dispenser 114, various signals may be received by LLS 112 indicative of the various surfaces by which the signals are reflected. For instance, a signal may be received indicative of a bottom surface of dispenser 114 (e.g., signal 143). Such signal may correspond to the baseline signal described above (e.g., according to a first operating mode if no user is detected or, alternately, according to a second operating mode if a user is detected). Further, a signal may be received indicative of top lip 115 of container 111 (e.g., signal 145), and a signal may be received indicative of the liquid water or ice level 119 within container 111 (e.g., signal 147). One or more signals may further be received indicative of the various geometries of container 111 (e.g., signal 149). For instance, container 111 includes a handle 113 extending horizontally from container 111. As shown, signal 149 is indicative of handle 113. As another example, if a container has a geometry wherein a middle portion 117 of the container has a larger radius than the top lip of the container, a signal may be received indicative of the middle portion 117, and a different signal may be received indicative of the top lip.

In example embodiments, top lip 115 may be identified based at least in part on the first received signal by LLS 112, such that the first received signal corresponds to the surface closest to the sensor (e.g., top lip 115). In this manner, the signal indicative of top lip 115 of container 111 may be distinguished from a signal indicative of, for instance, a middle portion 117 of container 111 (e.g., handle 113), or from a signal indicative of liquid water or ice in container 111. As described above, such signals may have an associated time intervals corresponding to the time it takes for the signal to travel from LLS 112, reflect off of a surface, and be received by LLS 112. The signal indicative of top lip 115 may have the shortest associated time interval.

After top lip 115 is identified, a liquid water or ice level 119 within container 111 may also be identified. In particular, as dispenser 114 dispenses liquid water or ice, the liquid water or ice level 119 within container 111 will rise. As the level rises, the time interval corresponding to the signal that reflects off of the liquid water or ice will decrease. The signal indicative of the liquid water or ice level 119 may be identified due at least in part to the change in the level of the liquid water or ice. In this manner, the signal indicative of the liquid water level may be distinguished, for instance, from a signal indicative of a protruding middle portion 117 of container 111. For instance, a signal indicative of the level of liquid water in container 111 (e.g., signal 147), and a signal indicative of a middle portion 117 of container 111 (e.g., signal 149) may each have time intervals that are less than the time interval associated with signal 143 (e.g., the baseline signal) but greater than the time interval associated with signal 145. In example embodiments, the signal indicative of the level of liquid water may be distinguished from the signal indicative of middle portion 117 due to the changing characteristics of the signal indicative of the liquid water level.

Once the signals indicative of top lip 115 and the liquid water or ice level 119 have been identified, the liquid water or ice level 119 may be measured relative to top lip 115. For instance, as the liquid water or ice level 119 rises, the distance between the liquid water or ice level 119 and top lip 115 decreases. When the distance between top lip 115 and the liquid water or ice level 119 falls below a threshold distance, dispenser 114 may be configured to cease dispensing liquid water or ice. The threshold distance may be, for instance, between about two centimeters (2 cm) and fifteen centimeters (15 cm). In example embodiments, the distance between top lip 115 and the liquid water or ice level 119 may be determined based on the difference between the time intervals of the respective signals. Dispenser 114 may be configured to cease dispensing liquid water or ice when the difference between the time intervals corresponds to the threshold distance.

In example embodiments, a signal indicative of ice in container 111 may be distinguished from a signal indicative of liquid water in container 111. For instance, a container may first contain an amount of ice when a user requests for liquid water to be dispensed, such that the rising liquid water level may not initially be detected by LLS 112 due at least in part to the presence of the ice in container 111. In such embodiments, when ice may be detected but not liquid water, dispenser 114 may be configured to blindly dispense liquid water for an initial time period although the liquid water level cannot initially be detected. For instance, the initial time period may be a predetermined time period, or may be determined at least in part from the determined height of container 111.

In certain embodiments, dispenser 114 may be configured to blindly dispense liquid water (e.g., as part of a blind-fill sequence separate from or in addition to an autofill sequence). For instance, a blind-fill sequence may be directed for an autofill sequence in instances wherein various portions of the container 111 cannot be immediately detected (e.g., until a liquid water level within container 111 may be detected). The blind-fill sequence may be directed according to a blind-fill time limit (e.g., defining a maximum time interval or period for which fluid may be dispensed during an autofill sequence when one or more portions of the container 111 or the water level therein cannot be detected). Thus, an autofill sequence may include or initiate a blind-fill sequence (e.g., immediately at the start of the autofill sequence or, alternatively, in response to a failure to detect a container within a set interval at the start of the autofill sequence). Moreover, the blind-fill sequence may permit detection of the container or fluid level while fluid is actively being dispensed. Thus, the LLS 112 may continue to collect signals in an attempt to detect the container or fluid level during the blind-fill sequence.

In some embodiments, the dispenser 114 may be configured to dispense liquid water until the distance between the liquid water level and top lip falls 115 below a threshold distance or until the blind-fill time limit expires. In some such embodiments, liquid water may still be dispensed even if the distance between the ice level and top lip 115 of container 111 is less than the threshold distance. For instance, if a level of ice is detected a half inch (0.5″) from the top lip of container 111, liquid water may still be dispensed. As the liquid water is dispensed into container 111, the overall level of contents in container 111 does not initially rise. In particular, the ice level and the liquid water level will converge as the ice settles and the liquid water level rises. Accordingly, in such embodiments, liquid water may be dispensed by dispenser 114 until the distance between the combined liquid water and ice level 119 and top lip 115 is less than the threshold distance (or the blind-fill time limit expires). As will be described in greater detail below, the blind-fill time limit may be a variable value (e.g., alternated between two or more predetermined values, such as a user-present limit and a user-absent limit) that is based, at least in part an evaluation of a user presence.

Turning now to FIGS. 4 through 7, the present disclosure may further be directed to algorithms or methods (e.g., method 400, 500, 600, or 700) of operating a dispenser assembly or appliance, such as dispenser assembly 110 or appliance 100. In exemplary embodiments, the controller 300 may be operable to perform various steps of an algorithm or method in accordance with the present disclosure.

The algorithms or methods (e.g., 400, 500, 600, or 700) may occur as, or as part of, an operation routine of dispenser assembly 110 or appliance 100. In particular, the algorithms or methods (e.g., 400, 500, 600, or 700) disclosed herein may advantageously provide an automated operation for dispensing fluid while preventing inadvertent execution or associated spills of fluid. Notably, the disclosed methods may ensure a user's presence prior to or during dispensing operations.

It is noted that the order of steps within algorithms or methods 400, 500, 600, and 700 are for illustrative purposes. Moreover, none of the algorithms or methods 400, 500, 600, and 700 are mutually exclusive. In other words, algorithms or methods within the present disclosure may include one or more of algorithms or methods 400, 500, 600, and 700. All may be adopted or characterized as being fulfilled in a common operation. Except as otherwise indicated, one or more steps in the below algorithms or methods 400, 500, 600, and 700 may be changed, rearranged, performed in a different order, or otherwise modified without deviating from the scope of the present disclosure.

Referring especially to FIG. 4, at 410, the method 400 includes receiving an autofill signal for the dispenser assembly. As an example, an autofill signal may be received from the user interface of the dispenser assembly. In particular, a corresponding input (e.g., rotary dial, push button, and touch pad) may be engaged, such as by a user, to indicate a desired autofill sequence. As an additional or alternative example, an autofill signal may be received from the liquid level sensor. In particular, the autofill signal may be transmitted (and subsequently received) in response to a user placing a container within the dispenser recess such that the container may be detected at the liquid level sensor (e.g., as described above).

At 420, the method 400 includes evaluating user presence. User presence may be detected, for instance, using the user-detection assembly. The detection at 420 may be separate from the liquid level sensor or movement of any door. As described above, the user-detection assembly may be able to determine if a user is or is not present (e.g., proximal to the dispenser assembly or appliance generally).

Specifically, evaluation may include receiving one or more detection signals from the user-detection assembly. As described above, the user-detection assembly might include one or more modules to detect a user's presence (e.g., based on user device/mobile display or a user's physical presence). As a result, 420 may include receiving a wireless connection signal from the user device. Such wireless connection signals may correspond to, for instance, Wi-Fi, Bluetooth, or some other appropriate communications medium. Additionally or alternatively, 420 may include receiving a presence signal corresponding to a physical body from the body sensor module. While the user-detection assembly is active, data therefrom may be transmitted to, for instance, the controller of the appliance as a detection signal.

Based the received signal, a user presence may be determined. As an example, a proximal-user condition may be determined if a user's presence is indicated by the received signal(s). Alternatively, a user-absence condition may be determined if a user's presence is not indicated by the received signal(s)—or a failure to determine a proximal-user condition is detected, as would be understood in light of the present disclosure.

Optionally, the presence of a user may be determined by nature of (e.g., in response to) receiving the detection signal(s). The presence detection (or attempts thereof) may be repeated continuously or at a predetermined interval (e.g., to ensure a user remains present).

In some embodiments, 420 is initiated subsequent (e.g., in response) to 410. Alternatively, 420 may be initiated independent of and prior to receiving the autofill signal. Thus, the user-detection assembly may remain active to attempt to detect a user even when no autofill input signal is received.

At 430, the method 400 includes directing the dispenser assembly (e.g., according to an autofill sequence). In some embodiments, 430 occurs subsequent to receiving the autofill signal. Additionally or alternatively, the dispenser assembly based on the evaluated user presence. Thus, the direction of the dispenser assembly may be influenced by or performed according to the evaluation at 420.

In some embodiments, a user-absence condition is determined (e.g., as described above). Based on the user-absence condition (e.g., the determination thereof), the dispenser assembly direction may include holding the dispenser assembly in a closed state (e.g., at a corresponding valve) to prevent the flow of fluid from the dispenser conduit. Thus, if it is determined that a user is absent or otherwise distal from the dispenser assembly, dispensing of fluid (e.g., according to an autofill sequence) may be prevented (e.g., irrespective or in spite of receiving an autofill signal). Optionally, the user interface may be configured to initiate or present an alert message. The alert message may be presented, for instance, at a speaker or display of the user interface to indicate that dispensing of the fluid is prevented or that a user's presence is not detected (e.g., as would be understood). The alert message may be configured as an audible noise, projected text, illuminated icon, digital image, etc. to communicate the closed state (e.g., to inform a present user that his/her presence is not detected).

In additional or alternative embodiments, a proximal-user condition is determined (e.g., as described above). Based on the proximal-user condition (e.g., the determination thereof), the dispenser assembly direction may include directing the dispenser assembly to an open state (e.g., at a corresponding valve) to dispense fluid from the dispenser conduit (e.g., according to an autofill sequence). Thus, if it is determined that a user is present, dispensing of fluid may be permitted (e.g., according to the autofill sequence, as described above).

It is noted that, as described above detection of a user may prompt alternating from a first operating mode (e.g., for the LLS) to a second operating mode. Thus, 430 may include applying one of a first operating mode or a second operating mode at the liquid level sensor or a second operating mode at the liquid level sensor based on the evaluated user presence, the second operating mode having a second sampling rate or scan interval less than a first sampling rate or scan interval of the first operating mode. For instance, in response to determination of a proximal-user condition, the second operating mode may be applied. Alternately, in response to determination of a user-absence condition, the first operating mode may be applied.

As further noted above, a blind-fill sequence may be provided (e.g., programmed within the controller separate from or in addition to an autofill sequence). In some such embodiments, 430 include initiating a blind-fill sequence according to a blind-fill time limit. As described above, the blind-fill time limit may generally provide a maximum time interval for dispensing fluid without detecting one or more portions of a container (e.g., while or following a container-detection failure). The blind-fill time limit may be provided as a variable value that can be changed based on the evaluated user presence. For instance, the blind-fill limit may be set as a user-present limit or a user-absent limit. Thus, the blind-fill limit may alternately be set as the user-present limit (e.g., based on or in response to a determined proximal-user condition) and the user-absent limit (e.g., based on or in response to a determined user-absence condition). The user-present limit and the user-absent limit may each be discrete set values or calculated based on a predetermined formula, chart, look-up table, or graph. Additionally or alternatively, the user-absent limit may be less than the user-present limit. In turn, determination that a user is not present (e.g., in a user-absence condition) may result in a blind-fill limit for a blind-fill or autofill sequence that is shorter than the resultant blind-fill limit when it is determined that a user is present (e.g., in a proximal-user condition).

Although the above described steps 410, 420, and 430 are described linearly, it is understood that certain steps may need to be repeated or mirrored during or as part of method 400. For instance, the liquid level sensor or user-presence assembly may be polled or used multiple times within a single instance of method 400. As an example, in some embodiments wherein 410 includes detecting a utensil at the liquid level sensor, the method 400 may further include determining a failure to receive an autofill input (e.g., at the user interface). Such an autofill input may be programmed as a prerequisite for 430. At 420, the user may be determined to be present (e.g., in a proximal-user mode). Thus, prior to 430, a container and user may be detected, but a required autofill input may be determined to be absent. In some such embodiments, the method 400 includes revaluating user presence (e.g., using the user-detection assembly, similar to 420). The reevaluation may be in response to determining the failure to receive the autofill input. Based on the reevaluation, the method 400 may halt or pause activation of the liquid-level sensor (e.g., for a set time period or until a programmed reactivation condition is met) or, alternatively, repeat 420. For instance, in response to a reevaluation determination that a user-absent condition is met, the method 400 may include halting or pausing activation of the liquid level sensor (i.e., directing the liquid level sensor to an inactive state in which detection of a container is not being attempted). Alternatively, in response to a reevaluation determination that a proximal-user condition is met, the method 400 may include repeating step 420 (e.g., as described above before proceeding to 430).

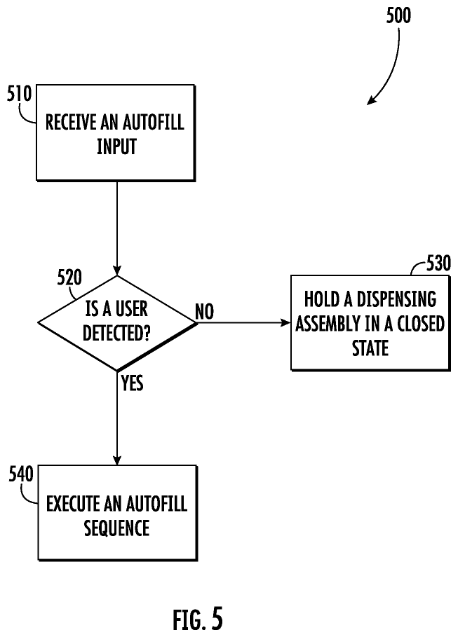

Turning now to FIG. 5, at 510, the method 500 includes receiving an autofill signal for the dispenser assembly. As an example, an autofill signal may be received from the user interface of the dispenser assembly. In particular, a corresponding input (e.g., rotary dial, push button, and touch pad) may be engaged, such as by a user, to indicate a desired autofill sequence. As an additional or alternative example, an autofill signal may be received from the liquid level sensor. In particular, the autofill signal may be transmitted (and subsequently received) in response to a user placing a container within the dispenser recess such that the container may be detected at the liquid level sensor (e.g., as described above).

At 520, following or in response to 510, the method 500 includes evaluating user presence. User presence may be detected, for instance, using the user-detection assembly. The detection at 520 may be separate from the liquid level sensor or movement of any door. As described above, the user-detection assembly may be able to determine if a user is or is not present (e.g., proximal to the dispenser assembly or appliance generally).

Specifically, evaluation may include receiving one or more detection signals from the user-detection assembly. As described above, the user-detection assembly might include one or more modules to detect a user's presence (e.g., based on user device/mobile display or a user's physical presence). As a result, 520 may include receiving a wireless connection signal from the user device. Such wireless connection signals may correspond to, for instance, Wi-Fi, Bluetooth, or some other appropriate communications medium. Additionally or alternatively, 520 may include receiving a presence signal corresponding to a physical body from the body sensor module. While the user-detection assembly is active, data therefrom may be transmitted to, for instance, the controller of the appliance as a detection signal.

Based the received signal, a user presence may be determined. Optionally, the presence of a user may be determined by nature of (e.g., in response to) receiving the detection signal(s). Notably, a proximal-user condition may be determined if a user's presence is indicated by the received signal(s). In response to such a determination, the method 500 may proceed to 540. Alternatively, a user-absence condition may be determined if a user's presence is not indicated by the received signal(s)—or a failure to determine a proximal-user condition is detected, as would be understood in light of the present disclosure. In response to such a determination, the method 500 may proceed to 530.

At 530, the method 500 includes holding the dispenser assembly in a closed state (e.g., at a corresponding valve) to prevent the flow of fluid from the dispenser conduit (e.g., in response to the determination at 520). Thus, if it is determined that a user is absent or otherwise distal from the dispenser assembly, dispensing of fluid (e.g., according to an autofill sequence) may be prevented (e.g., irrespective or in spite of receiving an autofill signal). Optionally, the user interface may be configured to initiate or present an alert message. The alert message may be presented, for instance, at a speaker or display of the user interface to indicate that dispensing of the fluid is prevented or that a user's presence is not detected (e.g., as would be understood). The alert message may be configured as an audible noise, projected text, illuminated icon, digital image, etc. to communicate the closed state (e.g., to inform a present user that his/her presence is not detected).

At 540, the method 500 includes executing an autofill sequence (e.g., as described above or in response to the determination at 520). Thus, 540 may include directing the dispenser assembly to an open state (e.g., at a corresponding valve) to dispense fluid from the dispenser conduit.

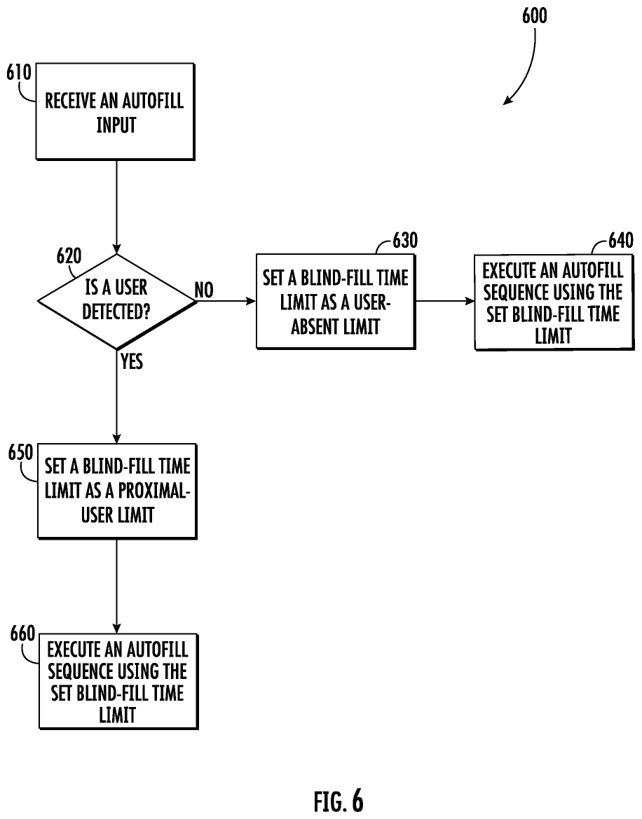

Turning now to FIG. 6, at 610, the method 600 includes receiving an autofill signal for the dispenser assembly. As an example, an autofill signal may be received from the user interface of the dispenser assembly. In particular, a corresponding input (e.g., rotary dial, push button, and touch pad) may be engaged, such as by a user, to indicate a desired autofill sequence. As an additional or alternative example, an autofill signal may be received from the liquid level sensor. In particular, the autofill signal may be transmitted (and subsequently received) in response to a user placing a container within the dispenser recess such that the container may be detected at the liquid level sensor (e.g., as described above).

At 620, following or in response to 610, the method 600 includes evaluating user presence. User presence may be detected, for instance, using the user-detection assembly. The detection at 620 may be separate from the liquid level sensor or movement of any door. As described above, the user-detection assembly may be able to determine if a user is or is not present (e.g., proximal to the dispenser assembly or appliance generally).

Specifically, evaluation may include receiving one or more detection signals from the user-detection assembly. As described above, the user-detection assembly might include one or more modules to detect a user's presence (e.g., based on user device/mobile display or a user's physical presence). As a result, 620 may include receiving a wireless connection signal from the user device. Such wireless connection signals may correspond to, for instance, Wi-Fi, Bluetooth, or some other appropriate communications medium. Additionally or alternatively, 620 may include receiving a presence signal corresponding to a physical body from the body sensor module. While the user-detection assembly is active, data therefrom may be transmitted to, for instance, the controller of the appliance as a detection signal.

Based the received signal, a user presence may be determined. Optionally, the presence of a user may be determined by nature of (e.g., in response to) receiving the detection signal(s). Notably, a proximal-user condition may be determined if a user's presence is indicated by the received signal(s). In response to such a determination, the method 600 may proceed to 650. Alternatively, a user-absence condition may be determined if a user's presence is not indicated by the received signal(s)—or a failure to determine a proximal-user condition is detected, as would be understood in light of the present disclosure. In response to such a determination, the method 600 may proceed to 630.

At 630, the method 600 includes setting a blind-fill time limit as a user-absent limit. As noted above, the blind-fill time limit may be provided as a variable value that can be changed based on the evaluated user presence. Thus, the blind-fill limit may be set as the user-absent limit (e.g., based on or in response to a determined user-absence condition at 620). By setting the user-absent limit, the controller may select a limit value (e.g., from a plurality of predetermined values) or calculate a limit value based on a predetermined formula, chart, look-up table, or graph before the method 600 proceeds to 640.

At 640, the method 600 includes executing or initiating a blind-fill sequence according to the user-absent time limit. As described above, the blind-fill time limit may generally provide a maximum time interval for dispensing fluid without detecting one or more portions of a container (e.g., while or following a container-detection failure). Moreover, a first operating mode may be applied such that the LLS operates at a first sampling rate or first set interval during the blind-fill sequence.

At 650, the method 600 includes setting a blind-fill time limit as a proximal-user limit (e.g., as described above or in response to the determination at 630). Again, as noted above, the blind-fill time limit may be provided as a variable value that can be changed based on the evaluated user presence. Thus, the blind-fill limit may be set as the proximal-user limit (e.g., greater than the user-absent limit and based on or in response to a determined user-absence condition at 620). By setting the proximal-user limit, the controller may select a limit value (e.g., from a plurality of predetermined values) or calculate a limit value based on a predetermined formula, chart, look-up table, or graph before the method 600 proceeds to 660.

At 660, the method 600 includes executing or initiating a blind-fill sequence according to the proximal-user time limit. As described above, the blind-fill time limit may generally provide a maximum time interval for dispensing fluid without detecting one or more portions of a container (e.g., while or following a container-detection failure). Moreover, a second operating mode may be applied such that the LLS operates at a second sampling rate or second set interval (e.g., greater than the first sampling rate or set interval) during the blind-fill sequence.

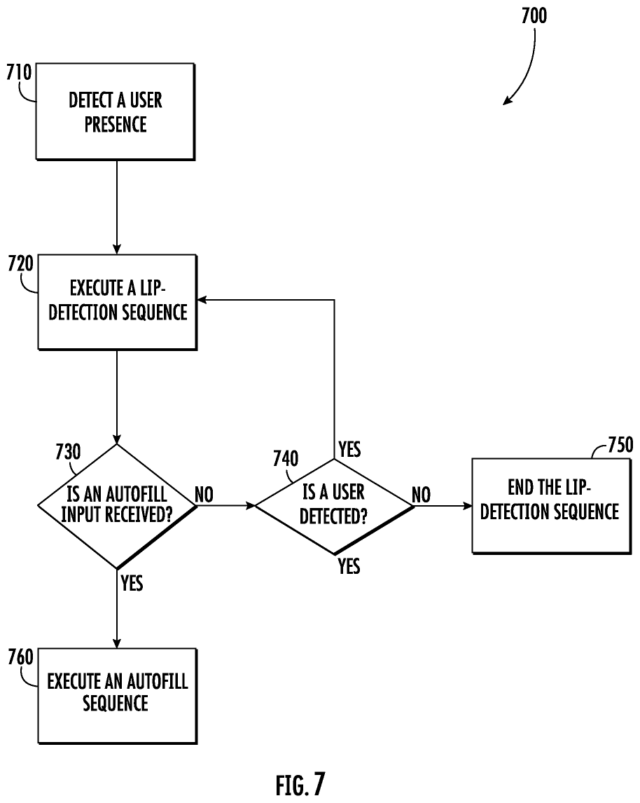

Turning now to FIG. 7, at 710, the method 700 includes detecting a user presence. User presence may be detected, for instance, using the user-detection assembly. The detection at 710 may be separate from the liquid level sensor or movement of any door. As described above, the user-detection assembly may be able to determine if a user is or is not present (e.g., proximal to the dispenser assembly or appliance generally). For instance, the user-detection assembly may be configured to continuously or repeatedly inspect the proximal area for a user's presence (e.g., as described above).

At 720, the method 700 includes executing a lip-detection sequence (e.g., following or in response to 710). For instance, the liquid level sensor may be activated to transmit one or more signals (e.g., sound waves) or capture an image to detect a top lip of a container disposed within the dispenser assembly (e.g., as described above). Following initiation of the lip-detection sequence, the method 700 may proceed to 730.

At 730, the method 700 includes determining if an autofill input is or has been received subsequent to (e.g., within a set time interval from) 710 or 720. As described above, an autofill input may be received from a user interface, such as to positively indicate a user's engagement or desire to commence an autofill sequence. Thus, 730 may include determining an autofill signal is received or, alternately, determining an autofill signal is not received (e.g., within the set time interval). In response to determining the autofill signal is received, the method 700 may proceed to 760. Alternately, in response to determining the autofill signal is not received, the method may proceed to 740.

At 740, the method 700 includes reevaluating user presence. User presence may be detected again, for instance, using the user-detection assembly. The detection at 740 may be separate from the liquid level sensor or movement of any door. As described above, the user-detection assembly may be able to determine if a user is or is not present (e.g., proximal to the dispenser assembly or appliance generally).

Specifically, reevaluation may include receiving one or more detection signals from the user-detection assembly. As described above, the user-detection assembly might include one or more modules to detect a user's presence (e.g., based on user device/mobile display or a user's physical presence). As a result, 740 may include receiving a wireless connection signal from the user device. Such wireless connection signals may correspond to, for instance, Wi-Fi, Bluetooth, or some other appropriate communications medium. Additionally or alternatively, 740 may include receiving a presence signal corresponding to a physical body from the body sensor module. While the user-detection assembly is active, data therefrom may be transmitted to, for instance, the controller of the appliance as a detection signal.

Based the received signal, a user presence may be determined. Optionally, the presence of a user may be determined by nature of (e.g., in response to) receiving the detection signal(s). Notably, a proximal-user condition may be determined if a user's presence is indicated by the received signal(s). In response to such a determination, the method 700 may return to or repeat 720. Alternatively, a user-absence condition may be determined if a user's presence is not indicated by the received signal(s)—or a failure to determine a proximal-user condition is detected, as would be understood in light of the present disclosure. In response to such a determination, the method 700 may proceed to 750.

At 750, the method 700 includes ending the lip-detection sequence initiated at 720. Optionally, the method 700 may be halted or paused (e.g., until a new detected presence is provided to restart the method 700 at 710).

At 760, the method 700 includes executing an autofill sequence (e.g., as described above or in response to the determination at 730). Thus, 760 may include directing the dispenser assembly to an open state (e.g., at a corresponding valve) to dispense fluid from the dispenser conduit.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance comprising:
a cabinet defining a storage compartment;
a door attached to the cabinet to selectively restrict access to the storage compartment;
a dispenser assembly attached to the cabinet at a dispenser recess, the dispenser assembly comprising
a dispenser conduit disposed within the dispenser recess, and
a liquid level sensor mounted at the dispenser recess to detect a volume below the dispenser conduit;
a user-detection assembly mounted to the cabinet to detect a user presence; and
a controller operably coupled to the dispenser assembly and the user-detection assembly, the controller being configured to initiate an operation routine comprising
receiving an autofill signal for the dispenser assembly,
evaluating user presence using the user-detection assembly, and
directing, subsequent to receiving the autofill signal, the dispenser assembly based on the evaluated user presence.

2. The refrigerator appliance of claim 1, wherein evaluating user presence is in response to receiving the autofill signal.

3. The refrigerator appliance of claim 2, wherein evaluating user presence comprises determining a user-absence condition, and
wherein directing the dispenser assembly comprises holding the dispenser assembly in a closed state to prevent the flow of fluid from the dispenser conduit.

4. The refrigerator appliance of claim 2, wherein evaluating user presence comprises determining a proximal-user condition, and
wherein directing the dispenser assembly comprises directing the dispenser assembly to an open state to dispense fluid from the dispenser conduit according to an autofill sequence.

5. The refrigerator appliance of claim 1, wherein evaluating user presence occurs independent of and prior to receiving the autofill signal.

6. The refrigerator appliance of claim 5, wherein receiving the autofill signal comprises detecting a container at the liquid level sensor.

7. The refrigerator appliance of claim 6, wherein the operation routine further comprises
determining a failure to receive an autofill input at a user interface of the refrigerator appliance, and
revaluating user presence using the user-detection assembly in response to determining the failure to receive the autofill input.

8. The refrigerator appliance of claim 6, wherein the operation routine further comprises receiving an autofill input at a user interface of the refrigerator appliance subsequent to receiving the autofill signal, wherein directing the dispenser assembly comprises directing the dispenser assembly to an open state to dispense fluid from the dispenser conduit according to an autofill sequence in response to receiving the autofill input.

9. The refrigerator appliance of claim 1, wherein directing the dispenser assembly comprises initiating a blind-fill sequence according to a blind-fill time limit, the blind-fill time limit being based on the evaluated user presence as a user-present limit or a user-absent limit, the user-absent limit being less than the user-present limit.

10. The refrigerator appliance of claim 1, wherein directing the dispenser assembly comprises applying one of a first operating mode or a second operating mode at the liquid level sensor or a second operating mode at the liquid level sensor based on the evaluated user presence, the second operating mode having a second sampling rate or scan interval that is less than a first sampling rate or scan interval of the first operating mode.

11. A dispenser appliance comprising:
a cabinet;
a dispenser assembly attached to the cabinet, the dispenser assembly comprising
a dispenser conduit, and
a liquid level sensor to detect a volume below the dispenser conduit;
a user-detection assembly mounted to the cabinet to detect a user presence; and
a controller operably coupled to the dispenser assembly and the user-detection assembly, the controller being configured to initiate an operation routine comprising
receiving an autofill signal for the dispenser assembly,
evaluating user presence using the user-detection assembly, and
directing, subsequent to receiving the autofill signal, the dispenser assembly based on the evaluated user presence.

12. The dispenser appliance of claim 11, wherein evaluating user presence is in response to receiving the autofill signal.

13. The dispenser appliance of claim 12, wherein evaluating user presence comprises determining a user-absence condition, and
wherein directing the dispenser assembly comprises holding the dispenser assembly in a closed state to prevent the flow of fluid from the dispenser conduit.

14. The dispenser appliance of claim 12, wherein evaluating user presence comprises determining a proximal-user condition, and
wherein directing the dispenser assembly comprises directing the dispenser assembly to an open state to dispense fluid from the dispenser conduit according to an autofill sequence.

15. The dispenser appliance of claim 11, wherein evaluating user presence occurs independent of and prior to receiving the autofill signal.

16. The dispenser appliance of claim 15, wherein receiving the autofill signal comprises detecting a container at the liquid level sensor.

17. The dispenser appliance of claim 16, wherein the operation routine further comprises
determining a failure to receive an autofill input at a user interface of the dispenser appliance, and
revaluating user presence using the user-detection assembly in response to determining the failure to receive the autofill input.

18. The dispenser appliance of claim 16, wherein the operation routine further comprises receiving an autofill input at a user interface of the dispenser appliance subsequent to receiving the autofill signal, wherein directing the dispenser assembly comprises directing the dispenser assembly to an open state to dispense fluid from the dispenser conduit according to an autofill sequence in response to receiving the autofill input.

19. The dispenser appliance of claim 11, wherein directing the dispenser assembly comprises initiating a blind-fill sequence according to a blind-fill time limit, the blind-fill time limit being based on the evaluated user presence as a user-present limit or a user-absent limit, the user-absent limit being less than the user-present limit.

20. The dispenser appliance of claim 11, wherein directing the dispenser assembly comprises applying one of a first operating mode or a second operating mode at the liquid level sensor or a second operating mode at the liquid level sensor based on the evaluated user presence, the second operating mode having a second sampling rate or interval less than a first sampling rate or interval of the first operating mode.
